(19) United States
(12) Patent Application Publication
(10) Pub. No.: US 2010/0215976 A1
(43) Pub. Date: Aug. 26, 2010

(54) PROTECTIVE FILM FOR IMAGE DISPLAY APPARATUS AND IMAGE DISPLAY APPARATUS COMPRISING THE SAME

(76) Inventors: Toshihiro Suwa, Sagamihara (JP); Sawako Kojima, Tokyo (JP)

Correspondence Address: 3M INNOVATIVE PROPERTIES COMPANY, PO BOX 33427, ST. PAUL, MN, 55133-3427, US

(21) Appl. No.: 12/738,555

(22) PCT Filed: Oct. 10, 2008
(86) PCT No.: PCT/US08/79528

§ 371 Date: Apr. 16, 2010

(30) Foreign Application Priority Data
Oct. 24, 2007 (JP) 2007-276901

(51) Int. Cl. B32B 27/30; B32B 27/00

(52) U.S. Cl. 428/522; 428/411.1

(57) ABSTRACT

The present disclosure is to provide a protective film for an image display apparatus, wherein a protection layer is allowed to be formed on an image display unit with a transparent polymer material interposed therebetween. A protective film for image display apparatus, which comprises an outermost layer including a first polymer film and a second layer including a second polymer film whose storage elastic modulus at 70° C. is 5.0×10⁶ Pa or more.

### TECHNICAL FIELD

The present disclosure relates to a protective film for an image display apparatus and an image display apparatus comprising the same.

### BACKGROUND

A glass or plastic film is placed as a protection layer on a display of an image display apparatus in an electronic apparatus such as a cellular phone and computer display. The protection layer has been fixed on a display with a tape or an adhesive set in a frame shape outside the image display region, and therefore there has existed a gap between the image display region and the protection layer. In recent years, a method by which the gap between the image display screen and the protection layer is replaced with a transparent material whose refractive index is closer to that of the image display screen, glass or plastic resin than the refractive index of air, so as to enhance transparency and to display an image more clearly is becoming popular. Examples of the transparent material include transparent polymer materials such as a transparent resin sheet, a pressure-sensitive adhesive and a curable adhesive (e.g., silicone gel).

Japanese Unexamined Patent Publication (Kokai) No. 09-197387 describes a production method of a liquid crystal display apparatus, in which a transparent resin sheet comprising a plasticizer-containing polymer is placed between a liquid crystal display panel and a transparent protection plate, a volatile liquid is charged in one or both gaps between the transparent resin sheet and the liquid crystal display panel and/or the transparent protection plate, such that a visible side of the liquid crystal display panel and the transparent protection plate intimately contact.

Japanese Unexamined Patent Publication (Kokai) No. 06-59253 describes a production method of liquid crystal display apparatus, which uses a reaction curing silicone gel, which is a colorless, transparent and elastic resin, between a liquid crystal panel and a glass plate. The colorless, transparent and elastic resin is injected in a liquid form and then cured, so as to bond the liquid crystal display panel with the glass plate.

Japanese Unexamined Patent Publication (Kokai) No. 03-204616 describes a liquid crystal display, in which a transparent polymer material is charged between a liquid crystal display device and a protection plate. Unsaturated polyester dissolved in a polymerizable monomer is used as the transparent polymer material, and this is injected in a gap between the liquid crystal display device and the protection plate and solidified.

### SUMMARY

At present, a transparent glass plate is used as a protection layer. The transparent glass plate can favorably function by maintaining adhesiveness even when exposed to an environment of high temperature and high humidity upon use, when it is contacted to a transparent polymer material. However, glass may scatter when it breaks, and the cost of the material itself is high. Therefore, the use of a highly transparent polymer film such as an acrylic resin like polymethyl methacrylate (PMMA) and polycarbonate instead of a transparent glass plate has been studied. However, there are cases where bubbles are generated or the transparent polymer material is exfoliated, when the polymer film and a transparent polymer material (such as an adhesive) are pasted together and exposed to a high temperature and high humidity environment.

In order to respond to recent trends such as downsizing in thickness and weight of an image display apparatus and increasing image sharpness, using a polymer film as a protection layer of an image display apparatus and fixing the polymer film on an image display unit with a transparent polymer material interposed between them is desired.

### BRIEF DESCRIPTION OF THE DRAWINGS

FIG. 1 is a sectional view showing an aspect of an image display apparatus including the protective film of the present disclosure.

FIG. 2 is a sectional view showing another aspect of an image display apparatus including the protective film of the present disclosure.

FIG. 3 is a sectional view showing yet another aspect of an image display apparatus including the protective film of the present disclosure.

FIG. 4 is a sectional view showing yet another aspect of an image display apparatus including the protective film of the present disclosure.

FIG. 5 is a sectional view showing yet another aspect of an image display apparatus including the protective film of the present disclosure.

### DETAILED DESCRIPTION

One aspect of the present description provides a protective film for an image display apparatus, comprising an outermost layer containing a first polymer film and a second layer containing a second polymer film having a storage elastic modulus at 70° C. of 5.0×10⁶ Pa or more.

Another aspect provides a laminate, comprising the protective film of an image display apparatus and a transparent polymer material, in which a second layer of the protective film for the image display apparatus is disposed adjacent to the transparent polymer material. Further, another aspect provides an image display apparatus comprising an image display unit, a transparent polymer material and the protective film for an image display apparatus. Further, another aspect provides an electronic device comprising the image display apparatus.

In the present disclosure, “storage elastic modulus” denotes the storage elastic modulus measured by means of raising the temperature from 0° C. to 200° C. at a rate of 5° C./min under a tension mode (10 Hz).

The protective film for an image display apparatus of the present disclosure develops adhesiveness at the interface with the transparent polymer material, and suppresses bubble generation and exfoliation at the interface.

According to an aspect, the protective film of the present disclosure comprises an outermost layer which includes a first polymer film and a second layer which includes a second polymer film having a storage elastic modulus at 70° C. of 5.0×10⁶ Pa or more. The outermost layer denotes a layer arranged at the outermost surface when a protective film is disposed on an image display apparatus. The outermost layer can be composed of the first polymer film alone, or it can be composed of a plurality of layers including the first polymer film. The first polymer film in the outermost layer may be a film that has been conventionally used as a protective film for an image display apparatus, such as an acrylic resin film including polymethyl methacrylate (PMMA) and a polycarbonate resin film. Although the thickness of the first polymer film is not limited, it is commonly from 0.1 to 5 mm.

A layer which imparts some functional features to the outermost layer, such as anti-wearing, abrasion resistance, antifouling, antireflective and antistatic properties, can be formed on the first polymer film in the outermost layer, i.e., on the observer side of the image display apparatus. The layer that imparts anti-wearing and abrasion resistant properties can be formed by means of applying a curing resin composition capable of forming a hard coat, followed by curing the same. For example, a cured film is formed by applying a coating material, which comprises a partially condensation reaction product of an alkyltrialkoxy silane-based silane mixture and colloidal silica, followed by thermal curing thereof, or is formed by applying a polyfunctional acrylate-based coating material, followed by irradiation of ultraviolet rays on the coating film. In order to impart an antifouling property, a resin layer containing an organic silicone compound or a fluorine-based compound can be formed. Further, in order to obtain an antistatic property, a resin layer containing a surfactant or electroconductive particles can be formed. It is preferred that the layer imparting such a functional property does not deteriorate the transparency of the protective film, and is also as thin as possible within the scope of exhibiting the function. Although the thickness of the layer imparting a functional property is not limited, it is commonly from 0.05 to 10 μm.

Below the first polymer film in the outermost layer, i.e., at the side of the second layer, a printed layer, a hard coat layer, a deposition layer and the like can be contained. The thickness of the entire outermost layer is commonly from 0.1 to 6 mm.

The second layer contains a second polymer film whose storage elastic modulus at 70° C. is 5.0×10⁶ Pa or more. When the second layer is used as a protective film for an image display apparatus together with the outermost layer under an environment of high temperature and high humidity, the suppression effect on bubble generation and exfoliation can improve dramatically at the interface with the transparent polymer material. The storage elastic modulus of the second polymer film at 70° C. may be adjusted according to the thickness of the outermost layer and the kind of transparent polymer material. In general, since the second polymer film has a higher storage elastic modulus, bubble generation and exfoliation from the transparent polymer material tend to be suppressed. In a certain aspect, the storage elastic modulus of the second polymer film can be adjusted to 5.0×10⁷ Pa or more at 70° C. When the second layer, which contains the second film having a storage elastic modulus at 70° C. of 1.0×10⁸ Pa or more, is used, bubble generation and exfoliation at the interface with the transparent polymer material is sure to be suppressed under an environment of higher temperature and higher humidity.

Although the upper limit of the storage elastic modulus is not particularly limited, it is 5.0×10⁹ Pa.

The second layer can be composed of the second polymer film alone, but may contain a printed layer, a vapor-deposition layer and/or a hard coat layer. Even when the multiple layers are present, it is preferred that the second polymer film has a higher storage elastic modulus at 70° C. in view of the effect on bubble generation and exfoliation caused by a thermal behavior of all the layers.

In a certain aspect, the second layer is disposed adjacent to the outermost layer in the protective film. In another aspect, a second layer (i.e., a side of the second layer that is not a side of the outermost layer) can be contacted with the transparent polymer material. It is preferred that the second polymer film contained in the second layer is directly contacted with the transparent polymer film in view of the suppression effect on bubble generation and exfoliation at the interface.

Although the thickness of the second polymer film is not limited, it is commonly from 0.05 μm to 1 mm. Although the thickness of the entire second layer is also not limited, it is commonly from 0.05 μm to 2 mm.

The second polymer film can be a cured material of a curing resin composition. The curing resin composition may contain a curing resin component and, optionally, other components such as a solvent.

The storage elastic modulus of the above second polymer film is, for example, achieved by using a cured material of a curing resin composition having a crosslinking structure. Therefore, in an aspect, the curing resin composition is composed of at least one polyfunctional reactive acrylic compound selected from the group of a polyfunctional acrylic monomer, a polyfunctional acrylic oligomer and a polyfunctional acrylic polymer. The second polymer film contains a reaction product of at least one of the above polyfunctional reactive acrylic compound.

For example, such a resin composition contains a polyfunctional reactive acrylic compound having 2 or more ethylenically unsaturated bonds in an amount of 50% by mass or more based on the solid contents excluding a volatile component such as a solvent. Specifically, the resin composition contains a polyfunctional reactive acrylic compound of the following formula:

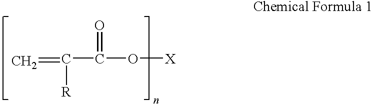

wherein R represents hydrogen or a methyl group; X represents an alcohol residual group derived from a polyvalent alcohol; and n represents an integer of 2 to 6, in an amount of 50% by mass or more. X is an alcohol residual group originating from a polyvalent alcohol, such as a residual group of an aliphatic hydrocarbon having a carbon number of from 4 to 10. In order to achieve the above storage elastic modulus, a rigid structure is more preferable than a flexible structure between crosslinking points. When the cured layer is thick, it is necessary to consider curing contraction, and combinational use of a tri- or higher functional acrylic compound and a difunctional acrylic compound is effective in this case.

More specific examples of the polyfunctional acrylic compound include 1,4-butanediol di(meth)acrylate, 1,3-butylene glycol di(meth)acrylate, 1,6-hexanediol di(meth)acrylate, 1,9-nonanediol di(meth)acrylate, neopentyl glycol di(meth)acrylate and the ethylene oxide (EO)-modified or propylene oxide (PO)-modified compound thereof, ethylene glycol di(meth)acrylate, diethylene glycol di(meth)acrylate, polyethylene glycol di(meth)acrylate, tripropylene glycol di(meth)acrylate, polypropylene glycol di(meth)acrylate, polytetramethylene glycol di(meth)acrylate, glycerol di(meth)acrylate, tricyclodecane-dimethylol di(meth)acrylate, isocyanuric acid ethylene oxide (EO)-modified diacrylate, triglycerol di(meth)acrylate, trimethylolpropane di(meth)acrylate, bisphenol A di(meth)acrylate and the ethylene oxide (EO)-modified or propylene oxide (PO)-modified compound thereof, and bisphenol F di(meth)acrylate and the ethylene oxide (EO)-modified or propylene oxide (PO)-modified compound thereof as examples of a difunctional acrylic compound.

The examples further include trimethylolpropane tri(meth)acrylate and the ethylene oxide (EO)-modified, propylene oxide (PO)-modified or caprolactone-modified compound thereof, pentaerythritol tri(meth)acrylate, pentaerythritol tetra(meth)acrylate and the EO-modified or PO-modified compound thereof, ditrimethylolpropane tetraacrylate, dipentaerythritol tri(meth)acrylate, dipentaerythritol tetra(meth)acrylate, dipentaerythritol penta(meth)acrylate and the ethylene oxide (EO)-modified, propylene oxide (PO)-modified, caprolactone-modified or alkyl-modified compound thereof, dipentaerythritol hexa(meth)acrylate and the (EO)-modified, propylene oxide (PO)-modified or caprolactone-modified compound thereof, tris((meth)acroyloyloxyethyl)isocyanurate and the caprolactone-modified compound thereof as examples of a tri- or higher functional acrylic compound.

Further, di- or higher functional epoxy acrylate, urethane acrylate and polyester acrylate are exemplified. The polyfunctional compound used in the curing resin composition, which has two or more ethylenically unsaturated bonds, can be used alone or in combination of two or more compounds thereof.

The curing resin composition may contain other monomers, such as a monofunctional acrylic compound, that are polymerizable with the above polyfunctional acrylic compound unless they contribute to decreasing the elastic modulus excessively. Examples of the monomers include (meth)acrylic acid, (meth)acrylate, acrylamide, vinyl ester and vinyl ether. The monomer compounds are contained in an amount of 50% by mass or less of the resin composition.

The above storage elastic modulus can be achieved even using a curing composition which contains a monofunctional acrylic polymerizable compound having a high glass transition temperature (Tg). In another aspect, the curing resin composition can contain an acrylic compound having a Tg exceeding 70° C., such as isobornyl acrylate (Tg=97° C.). Isobornyl acrylate is a favorable monomer even in the case of mixing the same with the polyfunctional acrylate upon use, due to its low curing contraction.

The curing resin composition provides a curing layer as follows: dissolve the curing resin component and an initiator if necessary in a proper solvent such as toluene, methyl ethyl ketone (MEK) and ethyl acetate; apply the resultant solution; dry the applied solution; and expose it to irradiation energy such as ultraviolet rays. The curing layer can also be obtained without using a solvent as follows: apply a mixture of the curing resin component and an initiator if necessary; and expose the applied mixture to irradiation energy such as ultraviolet rays. A proper initiator such as Irgacure (trademark) (manufactured by Ciba Japan K.K.) can be used in a proper amount. The amount of the initiator to be used is in general from 0.01 to 10% by mass based on the total weight of the curing resin components in the curing resin composition.

In another aspect, the curing resin layer can be formed by thermal curing of a polyfunctional acrylic polymer. In this case, the curing resin composition contains, for example, a (meth)acrylic ester polymer that has a crosslinkable group, and exhibits a storage elastic modulus as defined above after crosslinking. The crosslinkable group is a functional group that has reactivity with a crosslinking agent such as polyfunctional isocyanate, epoxy and aziridine compounds. Examples thereof include a hydroxyl group and carboxyl group.

The curing resin composition may contain other components unless the components damage the effect of the present disclosure. For example, it can contain an auxiliary photoinitiator, a tackifier, a viscosity adjusting agent, a leveling agent, an antiforming agent and an antioxidant.

The protective film of the present disclosure can be combined with a transparent polymer material to form a laminate. The laminate includes the above protective film and the transparent polymer material, and the second layer of the protective film is adjacent to the transparent polymer material. Various materials such as a pressure-sensitive adhesive, or another type of adhesive and a gel are used as the transparent polymer material. An example of the gel is a silicone gel, such as a two part curing, addition-type silicone. Such a silicone gel can be cured at room temperature in the presence of a catalyst. An example of the adhesive is a curing adhesive, and a curing adhesive containing a photocuring or thermosetting resin is exemplified.

The pressure-sensitive adhesive and other type of adhesive allowed to be used as the transparent polymer material are not limited. Examples thereof include acrylic pressure-sensitive adhesives, rubber pressure-sensitive adhesives, epoxy-based, silicone-based and urethane-based adhesives. In view of adhesiveness with the protective film and weather resistance, an acrylic pressure-sensitive adhesive is preferred. Hereinafter, the acrylic pressure-sensitive adhesive will be explained in detail.

The acrylic pressure-sensitive adhesive is derived from a plurality of (meth)acrylate monomers. It is designed on the ground of a glass transition temperature (Tg), cohesion force, wetting characteristic, low temperature property, high temperature property and the like of a (meth)acrylate polymer derived from the (meth)acrylate monomer. The (meth)acrylate polymer may also be derived from a combination of the above (meth)acrylate monomers and, for example, another ethylenically unsaturated monomer and/or an acidic monomer. It may also be polymerized with a reinforcing polymer to form a graft copolymer.

Particularly preferred (meth)acrylate monomers are exemplified by the (meth)acrylate of a non-tertiary alkyl alcohol, in which the carbon number of the alkyl group is about from 1 to 18, preferably about from 4 to 12, and a mixture thereof. Although the utilizable and favorable examples of a (meth)acrylate monomer are not limited in the present disclosure to those described hereinafter, they include methyl acrylate, ethyl acrylate, methyl methacrylate, ethyl methacrylate, n-butyl acrylate, n-butyl methacrylate, isobutyl acrylate, isobutyl methacrylate, hexyl acrylate, hexyl methacrylate, 2-ethylhexyl acrylate, 2-ethylhexyl methacrylate, isoamyl acrylate, isooctyl acrylate, isononyl acrylate, decyl acrylate, isodecyl acrylate, isodecyl methacrylate, lauryl acrylate, lauryl methacrylate, 2-methylbutyl acrylate, 4-methyl-2-pentyl acrylate, ethoxyethoxyethyl acrylate, 4-t-butylcyclohexyl methacrylate, cyclohexyl methacrylate, phenyl acrylate, phenyl methacylate, 2-naphthyl acrylate, 2-naphthyl methacrylate and a mixture thereof. Particularly preferred are 2-ethylhexyl acrylate, isooctyl acrylate, lauryl acrylate, n-butyl acrylate, ethoxyethoxyethyl acrylate and a mixture thereof. The (meth)acrylate monomer is used in an amount of 50% or more by mass based on the total mass of the monomers.

Although examples of the another ethylene-based unsaturated monomer are not limited to those described hereinafter, they include vinyl ester (such as vinyl acetate, vinyl pivalate and vinyl neononanoate), vinyl amide, N-vinyl lactam (such as N-vinyl pyrrolidone and N-vinyl caprolactam), (meth)acrylamide (such as N,N-dimethylacrylamide, N,N-dimethylmethacrylamide, N,N-diethylacrylamide and N,N-diethylmethacrylamide), (meth)acrylonitrile, maleic anhydride, styrene and a substituted styrene derivative (such as α-methylstyrene) and a mixture thereof. The another ethylenically unsaturated monomer is used in an amount of 30% by mass or less based on the total mass of the monomers.

An optional acidic monomer may be used for preparation of a (meth)acrylate polymer. Although the useful acidic monomers are not limited to those described hereinafter, they include ethylenically unsaturated carboxylic acid, ethylenically unsaturated sulfonic acid, ethylenically unsaturated phosphonic acid and a mixture thereof. Examples of such a compound include acrylic acid, methacrylic acid, itaconic acid, fumaric acid, crotonic acid, citraconic acid, maleic acid, β-carboxyethyl acrylate, 2-sulfoethyl methacrylate, styrene sulfonic acid, 2-acrylamide-2-methylpropane sulfonic acid, vinyl phosphonic acid and a mixture thereof. The acidic monomer is used in an amount of 20% by mass or less based on the total mass of monomers.

The acrylic pressure-sensitive adhesive may contain a (meth)acrylate polymer having a crosslinkable group. The crosslinkable group denotes a group that can form a crosslinkage structure in the acrylic pressure-sensitive polymer. The crosslinkage structure can raise the cohesion force of the pressure-sensitive polymer. The crosslinkable group is a functional group that has reactivity with a crosslinking agent such as polyfunctional isocyanate, epoxy and aziridine compounds. A hydroxyl group is exemplified. The hydroxyl group is reacted with polyfunctional isocyanate to form crosslinkage by a urethane bond. Examples of the monomer having a crosslinkable group include 2-hydroxyethyl acrylate, 2-hydroxyethyl methacrylate and 2-hydroxypropyl acrylate. The crosslinkable group may also be a group that allows radical polymerization, such as a (meth)acryloyl group. In this case, a crosslinking reaction takes place simultaneously upon the polymerization reaction, so that a crosslinking agent is unnecessary. Examples of the acrylate monomer having such a group include 1,2-ethylene glycol di(meth)acrylate, 1,4-butanediol di(meth)acrylate and 1,6-hexanediol di(meth)acrylate.

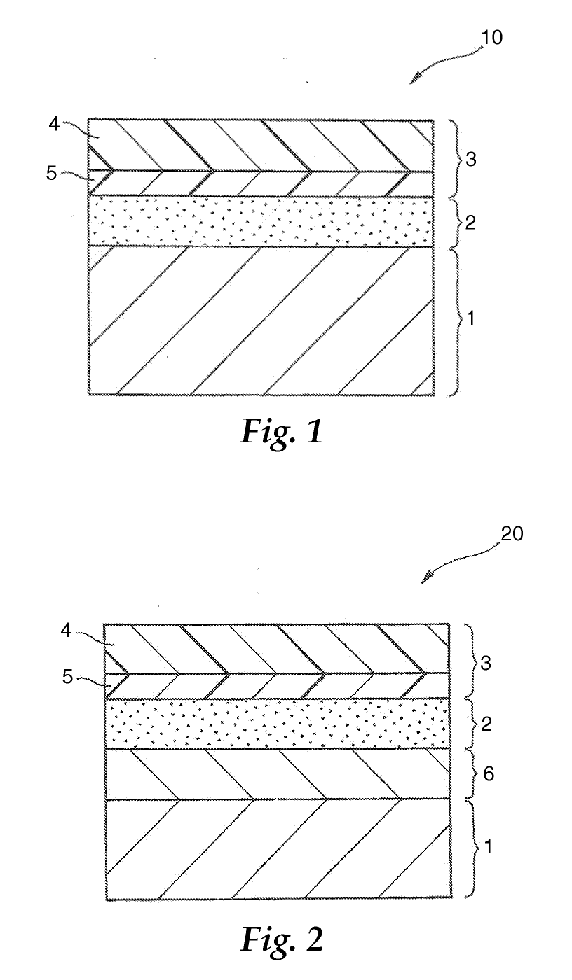

The image display apparatus using the above protective film will be explained with reference to FIGS. 1 to 5. The image display apparatus comprises an image display unit, the above transparent polymer material and the above protective film for image display apparatus. Herein, the image display unit is not particularly limited, and it can be a reflective or back light-type liquid crystal display unit, plasma display unit, electroluminescence (EL) display or electronic paper. The transparent polymer material is loaded on the image display apparatus by applying a tape-shaped adhesive sheet when the material is a pressure-sensitive adhesive, while it is done by injecting a liquid material between the protective film and the image display unit to cure when the material is a curing adhesive or gel. Among these, the method of applying an adhesive sheet is particularly preferred in view of easy loading and physical balance such as adhesiveness.

FIG. 1 is a sectional view showing an aspect of an image display apparatus including the protective film of the present disclosure. In an image display apparatus 10, a transparent polymer material 2 is disposed on an image display unit 1, and a protective film 3 is disposed thereon. The image display unit 1 is a back light-type liquid crystal display unit, for example. In the liquid crystal display unit, a reflector, a back light source, a light diffusion film, a luminescence enhancing film, a liquid crystal display panel and the like are disposed in order, although they are not shown in the drawing. The protective film 3 comprises an outermost layer 4 including a first polymer film and a second layer 5 including a second polymer film, and the second layer 5 is adjacent to the transparent polymer material 2.

FIG. 2 is a sectional view showing another aspect of an image display apparatus including the protective film of the present disclosure. An image display apparatus 20 has a structure in which a touch panel 6 is further disposed on the image display unit 1, and the transparent polymer material 2 is disposed on the touch panel. And thereon, the outermost layer 4 including the first polymer film, and the protective film 3 that includes the second layer 5 containing the second polymer film are disposed. The second layer 5 is adjacent to the transparent polymer material 2. Thus the protective film 3 can be used as a protection layer disposed on the outermost surface of the image display apparatus 20 with a touch panel. There are various systems in the touch panel 6, such as an electric capacitance system and resistance film system, but any system may be applied.

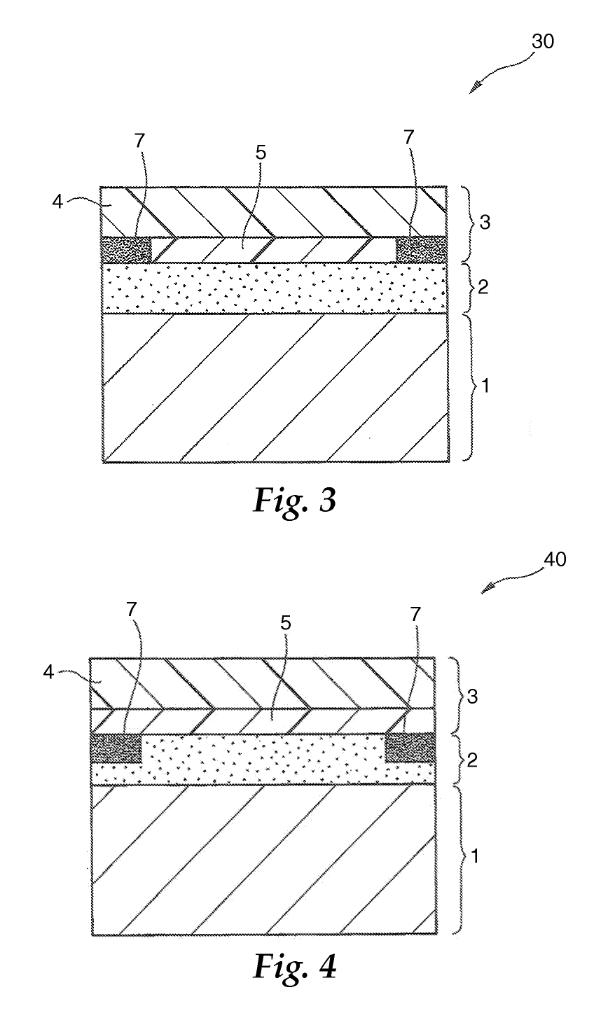

FIG. 3 is a sectional view showing yet another aspect of an image display apparatus including the protective film of the present disclosure. In FIG. 3, the transparent polymer material 2 is disposed on the image display unit 1 in an image display apparatus 30, and the protective film 3 of the present disclosure is disposed thereon. The protective film 3 comprises the outermost layer 4 including the first polymer film and the second layer 5 including the second polymer film, and the second layer 5 is adjacent to the transparent polymer material 2. Between the outermost layer 4 and the transparent polymer material 2, a light shielding layer 7 is disposed, providing a design. In display apparatuses such as liquid crystal display apparatuses, a light shielding layer is sometimes formed on some part of the display surface, in order to prevent leakage of light from a lateral face of display apparatus and to provide a design. The layer is commonly formed by applying a coating solution, prepared by introducing a colorant such as carbon black into a resin such as an acrylic resin, in a proper method such as screen printing. In FIG. 3, the shielding layer 7 and the second layer 5 are adjoining. In order to dispose the layer 5 and the layer 7 next to each other, a colorant is mixed in a coating solution of a curing resin composition for forming the second polymer film, the coating solution is applied on a predetermined area of the outermost layer 4 in a proper method such as screen printing, a coating solution of the curing resin composition containing no colorant is applied on the other area by screen printing or the like, and the coating solution is cured in a proper method such as UV irradiation, for example. Thus, the second layer 5 including the second polymer film and the light shielding layer 7 are formed.

FIG. 4 is a sectional view showing yet another aspect of an image display apparatus including the protective film of the present disclosure. In FIG. 4, the transparent polymer material 2 is disposed on the image display unit 1 in an image display apparatus 40, and the protective film 3 of the present disclosure is disposed thereon. The protective film 3 comprises the outermost layer 4 including the first polymer film and the second layer 5 including the second polymer film thereunder. Between the second layer 5 and the transparent polymer material 2, a light shielding layer 7 is disposed, providing a design. In order to dispose them as above, the following steps are taken: a colorant is mixed in a coating solution of a curing resin composition for forming the second polymer film; the coating solution is applied on a predetermined area of the outermost layer 4 in a proper manner such as screen printing; the coating solution is cured in a proper manner such as UV irradiation; and then the flexible transparent polymer material 2 is pasted on the image display unit 1, for example. The image display apparatus 40 is also obtained by the following steps: forming the layer 7; injecting a curing liquid into a gap with the image display unit 1; and curing the liquid.

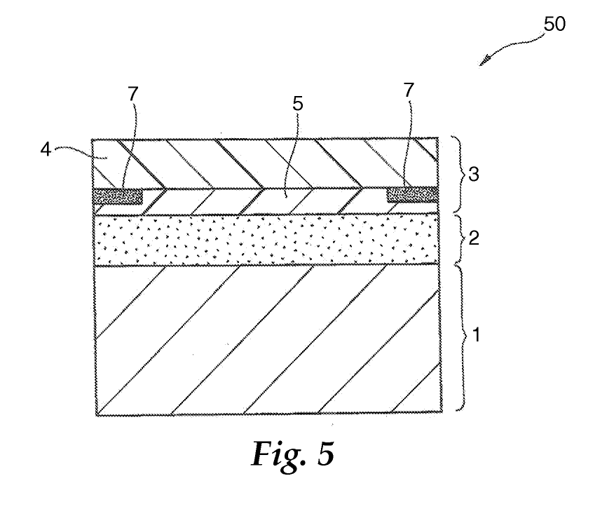

FIG. 5 is a sectional view showing yet another aspect of an image display apparatus including the protective film of the present disclosure. In FIG. 5, the transparent polymer material 2 is disposed on the image display unit 1 in an image display apparatus 50, and the protective film 3 of the present disclosure is disposed thereon. The protective film 3 comprises the outermost layer 4 including the first polymer film and the second layer 5 including the second polymer film thereunder. Between the outermost layer 4 and the second layer 5, the light shielding layer 7 is disposed, providing a design. In order to dispose them as above, the following steps are taken: a colorant is mixed in a coating solution of a curing resin composition for forming the second polymer film; the coating solution is applied on a predetermined area of the layer 4 in a proper manner such as screen printing; the coating solution is cured in a proper manner such as UV irradiation, a coating solution of a curing resin composition containing no colorant is applied on the entire surface by screen printing or the like; and then the solution is cured in a proper manner such as UV irradiation, for example.

In another aspect, the present disclosure relates to an electronic device including the above image display apparatus. The electronic device can be a cellular phone, personal digital assistance (PDA), portable video game machine, electronic reading terminal, car navigation system, portable music player, watch, television (TV), video camera, video player, digital camera, global positioning system (GPS) and personal computer (PC).

### EXAMPLES

The present disclosure will now be described by way of Examples.

### Example 1

### Production of Protective Film

Trimethylolpropane triacrylate (TMPTA) and Irgacure® 907, a photopolymerization initiator manufactured by Ciba Japan K.K., were mixed in an amount that corresponds to TMPTA/Irgacure 907=95/5% by mass. The mixture solution was diluted to be adjusted to 4% by mass with a mixture solvent of toluene and methyl ethyl ketone (MEK) (toluene/MEK=50/50% by mass), forming a coating solution.

The coating solution was coated on Acrylite® L (50 mm×80 mm×1.0 mm), a PMMA plate manufactured by Mitsubishi Rayon Co. Ltd., using a bar coater (ROD No. 4) manufactured by Nippon Seadus Service, and the solvent was dried. Then, ultraviolet rays were irradiated on the coated PMMA plate under a nitrogen atmosphere using a high pressure mercury lamp (H-type valve, 120 W/cm) manufactured by Fusion System Corp. The curing condition was 20 m/min×2 passes. Thus a protective film having PMMA and a cured acrylic layer was produced. The thickness of the cured layer was about 0.3 μm.

### Preparation of Evaluation Sample in Humidistat

One side of the release sheet of an acrylic transferring pressure-sensitive adhesive tape 8197 (trade number) (175 μm in thickness) manufactured by 3M was peeled off, and the tape was applied with a rubber roller on a cured acrylic layer disposed on the PMMA plate of a protective film prepared as above. Then, the other side of the liner sheet was peeled off, and a float glass (40 mm×70 mm×0.55 mm) was applied thereon using a rubber roller.

The resultant PMMA/acrylic cured layer/adhesive tape (PSA)/glass laminate was placed in an autoclave, and treated at 40° C. and 5 atm for 15 minutes.

The laminate was taken out of the autoclave, and allowed to stand at room temperature for about 3 hours. Then the PMMA/acrylic cured layer/PSA/glass laminate was placed in a humidistat of 70° C. and 90% RH. The laminate was taken out after 100 hours and examined by visual observation. No bubbles or exfoliations were found. The results are shown in Table 1.

### Measurement of Viscoelasticity

In order to measure the storage elastic modulus of the cured acrylic layer of the above protective film, the above coating solution was coated using a knife coater with a thickness of about 40 μm between two polyester films treated with silicone. Ultraviolet rays were irradiated on the sheet at 30 m/min using a high pressure mercury lamp (H-type valve, 120 W/cm) manufactured by Fusion System Corp. to polymerize TMPTA. The cured film was cut out 10 mm in width and 50 mm in length, forming a sample for measurement of viscoelasticity.

The evaluation of viscoelasticity was conducted under a tension mode (10 Hz) using RSAIII, dynamic mechanical spectrometer manufactured by TA Instruments. First, a strip of the sample was mounted on the device at room temperature, and the temperature of the sample was adjusted to be 0° C. Then, the sample temperature was elevated to 200° C. at a rate of 5° C./min, and the storage elastic modulus was measured. A graph of temperature (T) to storage elastic modulus (E′) was made. The storage elastic modulus (E′) of the sample at 70° C. is shown in Table 1.

### Comparative Example 1

A PMMA/cured acrylic layer/PSA/glass laminate was prepared in the same manner as in Example 1, except for using an untreated PMMA plate (Acrylite® L) on which a cured acrylic layer was not formed.

The laminate was placed in a humidistat of 70° C. and 90% RH. It was taken out after 100 hours and the outer appearance was examined by visual observation. A number of bubbles and exfoliations were observed.

### Comparative Example 2

A cured acrylic layer/PMMA/PSA/glass laminate was prepared in the same manner as in Example 1. A cured acrylic layer was formed on a surface of a PMMA plate using TMPTA, and the face where the cured acrylic layer was not formed and a PSA/glass laminate were bonded together.

The laminate was placed in a humidistat of 70° C. and 90% RH. It was taken out after 100 hours and the outer appearance was examined by visual observation. A number of bubbles and exfoliations were observed.

### Example 2

A PMMA/cured acrylic layer/PSA/glass laminate was prepared in the same manner as in Example 1, except for using pentaerythritol tetraacrylate (PETTA) instead of TMPTA in Example 1. A PMMA plate having a cured layer was formed, and the cured layer and a PSA/glass laminate were bonded together.

The laminate was placed in a humidistat of 70° C. and 90% RH. It was taken out after 100 hours and the outer appearance was examined by visual observation. No bubbles or exfoliations were observed.

A polymer film of PETTA was prepared in the same manner as in Example 1 and the viscoelasticity was measured. The results are shown in Table 1.

### Example 3

A PMMA/cured acrylic layer/PSA/glass laminate was prepared in the same manner as in Example 1, except for using dipentaerythritol hexaacrylate (DPHA) instead of TMPTA in Example 1. A PMMA plate having a cured layer was formed, and the cured layer and a PSA/glass laminate were bonded together.

The laminate was placed in a humidistat of 70° C. and 90% RH. It was taken out after 100 hours and the outer appearance was examined by visual observation. No bubbles or exfoliations were observed.

A polymer film of DPHA was prepared in the same manner as in Example 1 and the viscoelasticity was measured. The results are shown in Table 1.

### Example 4

A PMMA/cured acrylic layer/PSA/glass laminate was prepared in the same manner as in Example 1, except for using tricyclodecanedimethylol diacrylate (KAYARAD R-684 manufactured by Nippon Kayaku) instead of TMPTA in Example 1. A PMMA plate having a cured layer was formed, and the cured layer and a PSA/glass laminate were bonded together.

The laminate was placed in a humidistat of 70° C. and 90% RH. It was taken out after 100 hours and the outer appearance was examined by visual observation. No bubbles or exfoliations were observed.

A polymer film of tricyclodecanedimethylol diarylate was prepared in the same manner as in Example 1 and the viscoelasticity was measured. The results are shown in Table 1.

### Example 5

A PMMA/cured acrylic layer/PSA/glass laminate was prepared in the same manner as in Example 1, except for using Shiko® UV-1700B (urethane acrylate oligomer) manufactured by Nippon Synthetic Chemical Industry Co. Ltd. instead of TMPTA in Example 1. A PMMA plate having a cured layer was formed, and the cured layer and a PSA/glass laminate were bonded together.

The laminate was placed in a humidistat of 70° C. and 90% RH. It was taken out after 100 hours and the outer appearance was examined by visual observation. No bubbles or exfoliations were observed.

A polymer film of Shiko® UV-1700B was prepared in the same manner as in Example 1 and the viscoelasticity was measured. The results are shown in Table 1.

### Example 6

A PMMA/cured acrylic layer/PSA/glass laminate was prepared in the same manner as in Example 1, except for using Photomer® 3215 (epoxy acrylate oligomer) manufactured by Cognis Japan Ltd. instead of TMPTA in Example 1. A PMMA plate having a cured layer was formed, and the cured layer and a PSA/glass laminate were bonded together.

The laminate was placed in a humidistat of 70° C. and 90% RH. It was taken out after 100 hours and the outer appearance was examined by visual observation. No bubbles or exfoliations were observed.

A polymer film of Photomer® 3215 was prepared in the same manner as in Example 1 and the viscoelasticity was measured. The results are shown in Table 1.

### Example 7

A PMMA/cured acrylic layer/PSA/glass laminate was prepared in the same manner as in Example 1, except for using Shiko® UV-3000B (urethane acrylate oligomer) manufactured by Nippon Synthetic Chemical Industry Co. Ltd. instead of TMPTA in Example 1. A PMMA plate having a cured layer was formed, and the cured layer and a PSA/glass laminate were bonded together.

The laminate was placed in a humidistat of 70° C. and 90% RH. It was taken out after 100 hours and the outer appearance was examined by visual observation. Although a few bubbles were observed, the condition improved substantially as compared with the untreated PMMA plate (Comparative Example 1).

A polymer film of UV-3000B was prepared in the same manner as in Example 1 and the viscoelasticity was measured. The results are shown in Table 1.

### Example 8

A PMMA/cured acrylic layer/PSA/glass laminate was prepared in the same manner as in Example 1, except for using isobonyl acrylate (IBXA) instead of TMPTA in Example 1. A PMMA plate having a cured layer was formed, and the cured layer and a PSA/glass laminate were pasted together.

The laminate was placed in a humidistat of 70° C. and 90% RH. It was taken out after 100 hours and the outer appearance was examined by visual observation. Although a few bubbles were observed, the condition improved substantially as compared with the untreated PMMA plate (Comparative Example 1).

A polymer film of IBXA was prepared in the same manner as in Example 1 and the viscoelasticity was measured. The results are shown in Table 1.

### Comparative Example 3

A PMMA/cured acrylic layer/PSA/glass laminate was prepared in the same manner as in Example 1, except for using cyclohexyl acrylate (CHA) instead of TMPTA in Example 1. A PMMA plate having a cured layer was formed, and the cured layer and a PSA/glass laminate were bonded together.

The laminate was placed in a humidistat of 70° C. and 90% RH. It was taken out after 100 hours and the outer appearance was examined by visual observation. A number of bubbles and exfoliations were observed.

A polymer film of CHA was prepared in the same manner as in Example 1 and the viscoelasticity was measured. The results are shown in Table 1.

### Comparative Example 4

A PMMA/cured acrylic layer/PSA/glass laminate was prepared in the same manner as in Example 1, except for using NK ester AM-90G (methoxypolyethylene glycol acrylate) manufactured by Shin-Nakamura Chemical Co. Ltd. instead of TMPTA in Example 1. A PMMA plate having a cured layer was formed, and the cured layer and a PSA/glass laminate were bonded together.

The laminate was placed in a humidistat of 70° C. and 90% RH. It was taken out after 100 hours and the outer appearance was examined by visual observation. A number of bubbles and exfoliations were observed. A polymer film of NK ester AM-90G was prepared in the same manner as in Example 1. Since the film was very flexible at room temperature and had strong tackiness, the viscoelasticity was unable to be measured. However, it is obvious that the storage elastic modulus (E′) at 70° C. is 1.0×10⁶ (Pa) or less.

### Example 9

A cured acrylic layer was formed on a PMMA plate in the same manner as in Example 1, except for mixing TMPTA and Irgacure® 907 in a ratio of TMPTA/Irgacure=95/5% by mass, applying a coating solution without diluting the same with a solvent and using ROD No. 18 as a bar coater. The thickness of the cured layer was about 35 μm.

A PMMA/cured acrylic layer/PSA/glass laminate was prepared in the same manner as in Example 1, using the PMMA plate with the cured film thereon. The laminate was placed in a humidistat of 70° C. and 90% RH, and taken out after 100 hours. The outer appearance of the laminate was examined by visual observation. No bubbles or exfoliations were observed. The results are shown in Table 1.

### Example 10

A cured acrylic layer was formed on a PMMA plate in the same manner as in Example 9, except for mixing TMPTA, R-684 and Irgacure® 907 in a ratio of TMPTA/R-684/Irgacure=47.5/47.5/5% by mass, and applying a coating solution without diluting the same with a solvent.

A PMMA/cured acrylic layer/PSA/glass laminate was prepared in the same manner as in Example 9, using the PMMA plate with the cured film thereon. The laminate was placed in a humidistat of 70° C. and 90% RH, and taken out after 100 hours. The outer appearance of the laminate was examined by visual observation. No bubbles or exfoliations were observed.

A polymer film of TMPTA/R-684 was prepared in the same manner as in Example 1, and the viscoelasticity was measured. The results are shown in Table 1.

### Example 11

A laminate was prepared in the same manner as in Example 1, except for using a float glass mounting a polarization plate instead of a float glass. A PMMA plate with a cured acrylic layer formed thereon and a float glass mounting a polarization plate were bonded together using a transferring pressure-sensitive adhesive tape between them.

First, a polarizing plate with a pressure-sensitive adhesive layer HLC-5618S367AS manufactured by Panac Co. Ltd. and a float glass were bonded together using a rubber roller. A PMMA plate with a cured layer of TMPAT formed thereon was prepared according to Example 1. Then, the above adhesive tape was applied on the cured acrylic layer, followed by bonding the float glass mounting the polarization plate.

The resultant PMMA/cured acrylic layer/PSA/polarization plate/adhesive layer/glass laminate was placed in a humidistat of 70° C. and 90% RH, and taken out after 100 hours. The outer appearance of the laminate was examined by visual observation. No bubbles or exfoliations were observed. The results are shown in Table 1.

TABLE 1

| | | Cured layer | | | |
|---|---|---|---|---|---|
| | Cured layer material | material | | Storage elastic | |
| Example No. | (Monomer) | (Initiator) | Laminate structure | modulus (Pa) | Results |
| Example 1 | TMPTA (95 parts by mass %) | Irgacure 907 (5 | PMMA/Acrylic cured | 4.55 × 10⁸ | No bubbles or exfoliations |
| | | parts by mass %) | layer/PSA/Glass | | were observed |
| Example 2 | PETTA (95 parts by mass %) | Irgacure 907 (5 | PMMA/Acrylic cured | 4.71 × 10⁸ | No bubbles or exfoliations |
| | | parts by mass %) | layer/PSA/Glass | | were observed |
| Example 3 | DPHA (95 parts by mass %) | Irgacure 907 (5 | PMMA/Acrylic cured | 6.80 × 10⁸ | No bubbles or exfoliations |
| | | parts by mass %) | layer/PSA/Glass | | were observed |
| Example 4 | Tricyclodecanedimethylol | Irgacure 907 (5 | PMMA/Acrylic cured | 6.80 × 10⁸ | No bubbles or exfoliations |
| | diacrylate (KAYARAD | parts by mass %) | layer/PSA/Glass | | were observed |
| | R-684) (95% by mass) | | | | |
| Example 5 | Shiko UV-1700B (95% by | Irgacure 907 (5 | PMMA/Acrylic cured | 3.08 × 10⁸ | No bubbles or exfoliations |
| | mass) | parts by mass %) | layer/PSA/Glass | | were observed |
| Example 6 | Photomer ™ 3215 (95% by | Irgacure 907 (5 | PMMA/Acrylic cured | 1.05 × 10⁸ | No bubbles or exfoliations |
| | mass) | parts by mass %) | layer/PSA/Glass | | were observed |
| Example 7 | Shiko UV-3000B (95% by | Irgacure 907 (5 | PMMA/Acrylic cured | 5.70 × 10⁶ | Five or less bubbles or |
| | mass) | parts by mass %) | layer/PSA/Glass | | exfoliations were not |
| | | | | | observed |
| Example 8 | IBXA (95 parts by mass %) | Irgacure 907 (5 | PMMA/Acrylic cured | 2.26 × 10⁷ | Five or less bubbles or |
| | | parts by mass %) | layer/PSA/Glass | | exfoliations were not |
| | | | | | observed |
| Example 9 | TMPTA (thick coating) | Irgacure 907 (5 | PMMA/Acrylic cured | (4.55 × 10⁸)²⁾ | No bubbles or exfoliations |
| | (95% by mass) | parts by mass %) | layer/PSA/Glass | | were observed |
| Example 10 | TMPTA/KAYARAD R-684 | Irgacure 907 (5 | PMMA/Acrylic cured | 6.53 × 10⁸ | No bubbles or |
| | (thick coating) (95% by | parts by mass %) | layer/PSA/Glass | | exfoliations were |
| | mass) | | | | observed |
| Example 11 | TMPTA (95 parts by | Irgacure 907 (5 | PMMA/Acrylic cured | (4.55 × 10⁸)²⁾ | No bubbles or |
| | mass %) | parts by mass %) | layer/PSA/polarizing | | exfoliations were |
| | | | plate/adhesive | | observed |
| | | | layer/Glass | | |
| Comparative | None | None | PMMA/PSA/Glass | N.A. | A number of bubbles and |
| Example 1 | | | | | exfoliations were |
| | | | | | observed |
| Comparative | TMPTA (95 parts by | Irgacure 907 (5 | Acrylic cured | N.A. | A number of bubbles and |
| Example 2 | mass %) | parts by mass %) | layer/PMMA/PSA/Glass | | exfoliations were |
| | | | | | observed |
| Comparative | CHA (95 parts by mass %) | Irgacure 907 (5 | PMMA/Acrylic cured | 6.29 × 10⁵ | A number of bubbles and |
| Example 3 | | parts by mass %) | layer/PSA/Glass | | exfoliations were not |
| | | | | | observed |
| Comparative | NK ester AM-90G (95% by | Irgacure 907 (5 | PMMA/Acrylic cured | <<1.0 × 10^{6 1)} | A number of bubbles and |
| Example 4 | mass) | parts by mass %) | layer/PSA/Glass | | exfoliations were not |
| | | | | | observed |

¹⁾Impossible to measure because the sample is too soft and tacky
²⁾Indicates storage elastic modulus in Example 1 because the cured layer material of Examples 9 and 11 has the same composition as that in a cured layer material in Example 1

### Example 12

In the present Example, a cured layer was formed by thermocuring a mixture of a crosslinkable acrylic polymer having a functional group and a crosslinking agent applied on a PMMA plate, instead of curing a polyfunctional acrylic monomer applied on a PMMA plate with ultraviolet rays.

As a mixture of an acrylic polymer and a crosslinking agent, Overcoat Clear SG425 manufactured by Seiko Advance Ltd. was used. 10 parts by mass of the main part and 2 parts by mass of the crosslinking agent were mixed and defoamed by a hybrid mixer, and applied using a bar coater (ROD No. 4) manufactured by Nippon Seeders Service. A PMMA plated with the mixture solution applied thereon was allowed to stand in an oven at 80° C. for 1 hour. The solvent was dried off and a crosslinking reaction was promoted, forming a cured layer.

A PMMA/cured acrylic layer/PSA/glass laminate was prepared in the same manner as in Example 1, using the PMMA plate with the cured layer mounted thereon. The laminate was placed in a humidistat of 70° C. and 90% RH, and taken out after 100 hours. The outer appearance of the laminate was examined by visual observation. No bubble and exfoliation was observed.

The mixture solution was applied on a polyester film 50 μm thick treated with silicone, by adjusting the gap of a knife coater to 200 μm. This was dried and thermocured in an oven at 80° C. for 1 hour. The cured film of SG425 was peeled, and the viscoelasticity was measured in the same manner as in Example 1. The results are shown in Table 2.

### Example 13

As a mixture of an acrylic polymer and a crosslinking agent, Overcoat Clear SG429B manufactured by Seiko Advance Ltd. was used. 10 parts by mass of the base compound and 3 parts by mass of the crosslinking agent were mixed and defoamed by a hybrid mixer. A PMMA plated having a cured layer was formed in the same manner as in Example 12, and the curing layer and a PSA/glass laminate were pasted together to give a PMMA/cured acrylic layer/PSA/glass laminate.

The laminate was placed in a humidistat of 70° C. and 90% RH, and taken out after 100 hours. The outer appearance of the laminate was examined by visual observation. No bubbles or exfoliations were observed.

A cured film of SG429B was prepared in the same manner as in Example 12, and the viscoelasticity was measured. The results are shown in Table 2.

### Comparative Example 5

Instead of a mixture of the base compound and the crosslinking agent in Example 12, the base compound alone was applied and dried under the same conditions as in Example 12, forming a cured layer.

A PMMA/cured acrylic layer/PSA/glass laminate was prepared in the same manner as in Example 1, using the PMMA plate with the cured layer mounted thereon. The laminate was placed in a humidistat of 70° C. and 90% RH, and taken out after 100 hours. The outer appearance of the laminate was examined by visual observation. A number of bubbles and exfoliations were observed.

A cured film (dry film) consisting only of a base component of SG425 was prepared in the same manner as in Example 12, and the viscoelasticity was measured. The results are shown in Table 2.

### Comparative Example 6

Instead of a mixture of the main part and the crosslinking agent in Example 13, the main part alone was applied and dried under the same conditions as in Example 13, forming a cured layer.

A PMMA/cured acrylic layer/PSA/glass laminate was prepared in the same manner as in Example 1, using the PMMA plate with the cured layer mounted thereon. The laminate was placed in a humidistat of 70° C. and 90% RH, and taken out after 100 hours. The outer appearance of the laminate was examined by visual observation. A number of bubbles and exfoliations were observed.

A cured film (dry film) consisting only of the main part of SG429B was prepared in the same manner as in Example 13, and the viscoelasticity was measured. The results are shown in Table 2.

### Example 14

In the present Example, a cured layer was formed in the same manner as in Example 12, by thermocuring a mixture of a crosslinkable acrylic polymer having a functional group and a crosslinking agent applied on a PMMA plate, instead of curing a polyfunctional acrylic monomer applied on a PMMA plate with ultraviolet rays. An acrylic ester copolymer was synthesized as the acrylic polymer. 28 parts by mass of methyl ethyl ketone (MEK) and 0.012 parts by mass of a thermopolymerization initiator, 2,2-azobis(2,4-dimethyl baleronitrile) (product name: V-65, manufactured by Wako Pure Chemical Industry), were added to a mixture solution of 6.0 parts by mass of cyclohexyl acrylate (CHA), 4.8 parts by mass of isobonyl acrylate (IBXA) and 1.2 parts by mass of 2-hydroxyethyl acrylate (2-HEA) (CHA/IBXA/2-HEA=50/40/10% by mass). After purging the atmosphere with nitrogen for 5 minutes, the above mixture was reacted in a thermostatic chamber of 50° C. for 20 hours to give an acrylic polymer having a hydroxyl group and weight average molecular weight of 95,000 (in terms of styrene conversion based on gel permeation chromatography).

Next, 1.21 parts by mass of Coronate L-45E manufactured by Nippon Polyurethane Industry Co. Ltd. as an isocyanate-based crosslinking agent was mixed in 10.0 parts by mass of the resultant acrylic copolymer solution to prepare a coating solution. The coating solution was stirred and defoamed using a hybrid mixer, and coated over a PMMA plate using a bar coater (ROD No. 4) manufactured by Nippon Seeders Service. The PMMA plate with the mixture solution coated thereon was allowed to stand in an oven at 80° C. for 2 hours to dry the solvent and conduct a crosslinking reaction, forming a cured layer.

A PMMA/cured acrylic layer/PSA/glass laminate was prepared in the same manner as in Example 1, using the PMMA plate with the cured layer mounted thereon. The laminate was placed in a humidistat of 70° C. and 90% RH, and taken out after 100 hours. The outer appearance of the laminate was examined by visual observation. No bubbles or exfoliations were observed. The results are shown in Table 2.

The prepared solution was coated on a polyester film 50 μm thick treated with silicone, by adjusting the gap of a knife coater to 200 μm. This was dried in an oven at 80° C. for 2 hours, and a crosslinking reaction was conducted. The cured film was peeled, and the viscoelasticity was measured in the same manner as in Example 1. The results are shown in Table 2.

### Example 15

A methacrylic ester copolymer was synthesized as the acrylic polymer. 24.0 parts by mass of ethyl acetate and 0.032 parts by mass of V-65 were added to a mixture solution of 6.4 parts by mass of butyl methacrylate (BMA), 8.0 parts by mass of 2-ethylhexyl methacrylate (2-EHMA) and 1.6 parts by mass of 2-hydroxyethyl methacrylate (2-HEMA) (BMA/2-EHMA/2-HEMA=40/50/10% by mass). After purging the atmosphere with nitrogen for 5 minutes, the above mixture was reacted in a thermostatic chamber of 50° C. for 20 hours to give an acrylic polymer having a hydroxyl group and weight average molecular weight of 260,000 (in terms of styrene conversion based on gel permeation chromatography).

Next, 10.0 parts by weight of ethyl acetate and 0.86 parts by mass of Coronate L-45E were mixed in 6.0 parts by mass of the resultant acrylic copolymer solution and a coating solution was prepared. The coating solution was stirred and defoamed using a hybrid mixer, and coated over a PMMA plate using a bar coater (ROD No. 4) manufactured by Nippon Seeders Service. The PMMA plate with the mixture solution coated thereon was allowed to stand in an oven at 80° C. for 2 hours to dry the solvent and conduct a crosslinking reaction, forming a cured layer.

A PMMA/cured acrylic layer/PSA/glass laminate was prepared in the same manner as in Example 1, using the PMMA plate with the cured layer mounted thereon. The laminate was placed in a humidistat of 70° C. and 90% RH, and taken out after 100 hours. The outer appearance of the laminate was examined by visual observation. No bubbles or exfoliations were observed. The results are shown in Table 2.

The prepared solution was coated on a polyester film 50 μm thick treated with silicone, by adjusting the gap of a knife coater to 200 μm. This was dried in an oven at 80° C. for 2 hours, and a crosslinking reaction was conducted. The cured film was peeled, and the viscoelasticity was measured in the same manner as in Example 1. The results are shown in Table 2.

### Comparative Example 7

A coating solution was prepared without adding the isocyanate-based crosslinking agent to the acrylic polymer solution in Example 14. The coating solution was applied over the PMMA plate in the same manner as in Example 14, forming a cured layer.

A PMMA/cured acrylic layer/PSA/glass laminate was prepared in the same manner as in Example 1, using the PMMA plate with the cured layer mounted thereon. The laminate was placed in a humidistat of 70° C. and 90% RH, and taken out after 100 hours. The outer appearance of the laminate was examined by visual observation. A number of bubbles and exfoliations were observed. The results are shown in Table 2.

A cured film (dry film) consisting only of the acrylic polymer was prepared in the same manner as in Example 14, and the viscoelasticity was measured. The results are shown in Table 2.

### Comparative Example 8

A coating solution was prepared by mixing 10.0 parts by mass of ethyl acetate alone in 6.0 parts by mass of the acrylic polymer solution, without adding the isocyanate-based crosslinking agent, in Example 15. The coating solution was applied over the PMMA plate in the same manner as in Example 15, forming a cured layer.

A PMMA/cured acrylic layer/PSA/glass laminate was prepared in the same manner as in Example 1, using the PMMA plate with the cured layer mounted thereon. The laminate was placed in a humidistat of 70° C. and 90% RH, and taken out after 100 hours. The outer appearance of the laminate was examined by visual observation. A number of bubbles and exfoliations were observed. The results are shown in Table 2.

A cured film (dry film) consisting only of the acrylic polymer was prepared in the same manner as in Example 15, and the viscoelasticity was measured. The results are shown in Table 2.

TABLE 2

| | | | Storage elastic | |
|---|---|---|---|---|
| Example No. | Cured layer material (Monomer) | Laminate structure | modulus (Pa) | Results |
| Example 12 | Clear SG425 + Crosslinking agent | PMMA/Acrylic cured | 7.87 × 10⁶ | No bubbles or exfoliations were |
| | | layer/PSA/Glass | | observed |
| Example 13 | Clear SG4259B + Crosslinking | PMMA/Acrylic cured | 1.74 × 10⁷ | No bubbles or exfoliations were |
| | agent | layer/PSA/Glass | | observed |
| Example 14 | Poly(CHA/IBXA/2-HEA) + | PMMA/Acrylic cured | 3.94 × 10⁸ | No bubbles or exfoliations were |
| | Crosslinking agent | layer/PSA/Glass | | observed |
| Example 15 | Poly(BMA/2-EHMA/2-HEMA) + | PMMA/Acrylic cured | 2.72 × 10⁸ | No bubbles or exfoliations were |
| | Crosslinking agent | layer/PSA/Glass | | observed |
| Comparative | Clear SG425 (no crosslinking | PMMA/Acrylic cured | 1.38 × 10⁵ | A number of bubbles and |
| Example 5 | agent) | layer/PSA/Glass | | exfoliations were not observed |
| Comparative | Clear SG429B (no crosslinking | PMMA/Acrylic cured | 1.22 × 10⁶ | A number of bubbles and |
| Example 6 | agent) | layer/PSA/Glass | | exfoliations were not observed |
| Comparative | Poly(CHA/IBXA/2-HEA) | PMMA/Acrylic cured | 1.71 × 10⁶ | A number of bubbles and |
| Example 7 | (no crosslinking agent) | layer/PSA/Glass | | exfoliations were not observed |
| Comparative | Poly(BMA/2-EHMA/2-HEMA) | PMMA/Acrylic cured | 1.85 × 10⁶ | A number of bubbles and |
| Example 8 | (no crosslinking agent) | layer/PSA/Glass | | exfoliations were not observed |

### Example 16

In Example 1, the protective film comprising PMMA and the cured layer of TMPTA mounted thereon was prepared, and then a liquid photocurable adhesive was used instead of applying a transferring adhesive tape.

First, a PET film of 175 μm (5 mm×40 mm) was mounted as a spacer on both ends of a float glass. Then, a proper amount of Light-Weld® 425, a photocuring adhesive manufactured by Dymax Corp., was added dropwise onto the center of the glass. The protective film having the cured layer of TMPTA was pressed onto the glass, so as to spread the adhesive over the entire surface. Excessive adhesive was removed, and ultraviolet rays were irradiated using a high pressure mercury lamp (H-type valve, 120 W/cm) manufactured by Fusion System Corp. The curing condition was 20 m/min×5 passes. Thus, a PMMA/cured acrylic layer/adhesive/glass laminate was prepared.

The laminate was placed in a humidistat of 70° C. and 90% RH, and taken out after 100 hours. The outer appearance of the laminate was examined by visual observation. No bubbles or exfoliations were observed. The results are shown in Table 3.

### Example 17

A PMMA/cured acrylic layer/adhesive/glass laminate was prepared in the same manner as in Example 16, except for using Shiko® NS-002 manufactured by Nippon Synthetic Chemical Industry Co. Ltd. as a photocuring adhesive instead of Light-Weld® 425 manufactured by Dymax Corp. in Example 16.

The laminate was placed in a humidistat of 70° C. and 90% RH, and taken out after 100 hours. The outer appearance of the laminate was examined by visual observation. No bubbles or exfoliations were observed. The results are shown in Table 3.

TABLE 3

| | Transparent | |
|---|---|---|
| Example No. | polymer material | Results |
| Example 16 | Light-Weld ® 425 | No bubbles or |
| | | exfoliations were observed |
| Example 17 | Shiko ® NS-002 | No bubbles or |
| | | exfoliations were observed |

1. A protective film for an image display apparatus, comprising:
an outermost layer containing a first polymer film, and
a second layer containing a second polymer film having a storage elastic modulus at 70° C. of 5.0×10⁶ Pa or more.

2. The protective film for an image display apparatus according to claim 1, wherein the second layer is capable of bonding with a transparent polymer material.

3. The protective film for an image display apparatus according to claim 2, wherein the transparent polymer material is a pressure-sensitive adhesive.

4. The protective film for an image display apparatus according to claim 1, wherein the second polymer film contains a reaction product of at least one polyfunctional reactive acrylic compound selected from the group consisting of a polyfunctional acrylic monomer, a polyfunctional acrylic oligomer and a polyfunctional acrylic polymer.

5. The protective film for an image display apparatus according to claim 1, wherein the second polymer film has a storage elastic modulus at 70° C. of 1.0×10⁸ Pa or more.

6. A laminate comprising the protective film for an image display apparatus according to claim 1 and a transparent polymer material, the second layer of the protective film for an image display apparatus being adjacent to the transparent polymer material.

7. An image display apparatus comprising:
an image display unit,
a transparent polymer material, and
the protective film for an image display apparatus according to claim 1.

8. An electronic apparatus comprising the image display apparatus according to claim 7.
